(19) United States
(12) Patent Application Publication
(10) Pub. No.: US 2010/0085055 A1
(43) Pub. Date: Apr. 8, 2010

(54) METHOD OF MAPPING HYDROCARBON RESERVOIRS IN SHALLOW WATERS AND ALSO AN APPARATUS FOR USE WHEN PRACTISING THE METHOD

(76) Inventors: Pavel Barsukov, Amersfoort (NL); Eduard B. Fainberg, Amersfoort (NL); Bension Sh. Singer, Hafrsfjord (NO)

Correspondence Address: GABLE & GOTWALS, 100 WEST FIFTH STREET, 10TH FLOOR, TULSA, OK, 74103, US

(21) Appl. No.: 12/516,452

(22) PCT Filed: Nov. 26, 2007
(86) PCT No.: PCT/NO2007/000416

§ 371 Date: Jul. 14, 2009

(30) Foreign Application Priority Data
Nov. 27, 2006 (NO) 20065436

(51) Int. Cl. G01V 3/00

(52) U.S. Cl. 324/337

(57) ABSTRACT

A system for marine electromagnetic surveying of hydrocarbon reservoirs is proposed. The system proposed is characterized by high sensitivity to targets containing hydrocarbons and an ability to work in shallow and deep waters. The system includes a transmitter setting up current pulses in water (2) through a submerged, vertical or horizontal transmitter cable (7a, 7b, 8) and a registration subsystem (9) connected to electrodes (11) on vertical or horizontal receiver cables (10a, 10b). The transmitter generates a special sequence of sharply terminated pulses of the electric current, the electric field being measured in the water in the pauses between these pulses. The straight line through the receiver electrodes lies in the same vertical plane as the terminations of the transmitter cable (7a, 7b). The measurements are carried out with an offset between the transmitter cable (7a, 7b) and the receiver cables (10a, 10b) which is smaller than the depth of the targeted reservoir of hydrocarbons, measured from the sea floor (3).

The invention relates to a method and an apparatus for mapping subsea hydrocarbon reservoirs, more particularly by using the TM-mode of an electromagnetic field source for registering a TM-response which is measured by one or more receivers submerged in water, by the use of a substantially vertically or horizontally oriented transmitter and one or more substantially horizontally or, respectively, vertically oriented receivers, and by the generation of intermittent electric current pulses having sharp termination in the transmitter submerged in water, an electromagnetic field generated by these pulses being measured by the receiver/receivers, which is/are submerged in water, in the time interval when the current on the electromagnetic field source is switched off. The offset of the dipole of the electromagnetic field source and the dipole of the receiver is smaller than the depth to the target object.

Seismic measurements provide reliable information on the existence, location and shape of geological structures containing hydrocarbons. However, seismic measuring methods are often insufficient for determining the potential value of a reservoir and even have difficulties distinguishing between water and fluids containing hydrocarbon in the detected structures. Because of high cost of drilling in marine conditions, exploratory drilling is not very attractive without reliable seismic measurement results. The good capacities of electromagnetic (EM) measurements in measuring the resistivity of the content of a reservoir have become an important factor in the risk analyses of an exploration area.

The Controlled Source ElectroMagnetic (CSEM) methods are widely used in hydrocarbon exploration at sea. The most common CSEM systems include a horizontal transmitter dipole positioned on the sea floor. The dipole is supplied with a strong electric current. Horizontal electric receivers are installed on the sea floor with different offsets to the transmitter. Some modifications of such systems are described in patents by Srnka (1986), Ellingsrud et al. (2001-2005), Eidsmo et al. (2003), MacGregor et al. (2003) and in other publications listed below. In some of these systems magnetic measurements are complemented by electric ones.

The transmitter of the marine CSEM system usually generates either a harmonic current or a sequence of current pulses. After this has been stored, the electromagnetic fields set up by the harmonic current can be used for further interpretations. Unlike this, the field set up by current pulses is subject to transformation into the frequency domain. In particular, Fourier transform from the time into the frequency domain is used in seabed logging (SBL) which is currently the most used CSEM method.

The present marine CSEM systems can detect the target area provided that the horizontal distance between the signal source and receiver (the so-called offset) exceeds by many times the depth of the reservoir. This condition ensures that the EM-field will propagate from the transmitter to the receiver via the bedrock underneath the sediment structure. On the other hand, a great offset will make the measurements vulnerable to distortion as the EM-field propagates through air. According to Constable (2006) and Constable and Weiss (2006) the effect of the EM-field propagating through air makes the conventional SBL technique unusable for exploration in shallow waters, that is to say, the conventional SBL technique is considered unreliable for water depths of under 300 metres.

This drawback of the most popular CSEM system reflects a more fundamental issue, namely the fact that the transversal electric (TE) mode of the field contributes to the horizontal, in-line, electric field. It is known that the TE mode, unlike the transversal magnetic (TM) mode, is not very sensitive to resistive targets.

Edwards and Chave (1986) used a CSEM configuration measuring the step-on transient response for a horizontal, in-line electric dipole-dipole system. This configuration was later applied by Edwards (1997) to survey a deposit of gas hydrates. In the survey, the acquired in-line electric field was complemented by the broadside electric field. The broadside component is less sensitive with respect to resistive targets. Therefore, it can be used for determination of the background cross-section (Ellingsrud et al. 2001-2005) and enhances the deviant cross-section acquired in the in-line measurement. In these trials the transmitter-to-receiver offset was varied in the range 300 to 1300 m. This system showed higher resolution than SBL systems working in the conventional frequency domain. But it does not make it possible to explore for hydrocarbon reservoirs at depths exceeding several hundred metres.

Edwards et al. (1981, 1984, 1985) proposed a method of magnetometric electrical sounding at sea (Magnetometric Off-Shore Electrical Sounding Method—MOSES). The system consists of a vertical cable which extends from the sea surface to the seabed and is supplied with an alternating electric current. A magnetic sensor measures the azimuthal component of the magnetic field at the seabed. A clear advantage of MOSES is its reliability in the TM mode of the electromagnetic field. The drawbacks of the system are its large offset dimensions, which are necessary for providing a sufficient signal level and sensitivity to the deep parts of substrates, and the registration of the TE mode of the field, forming, together with the TM mode, the response from the investigated resistive structure, largely comprising noise.

The most common drawbacks of all the CSEM methods described are the necessity of using considerable offsets, generally exceeding the depth to the target by a factor of 5 to 10.

Barsukov et al. (2005), represented by the present applicant's patent publication NO 20055168, propose a TEMP-VEL configuration which features vertical transmitter and receiver lines for setting up a current in the sea and measuring the electric field. In that way the TEMP-VEL configuration generates in a layered stratum an electromagnetic field consisting of only the TM mode. Additionally, the system measures only the TM mode of the electromagnetic field. The TEMP-VEL configuration is set for late time measurement if the medium-time domain responds. The horizontal separation of the transmitter from the receiver is considerably smaller than the depth of the target. These characteristics of the system provide maximum sensitivity with respect to the resistive target.

Unlike SBL systems of the frequency domain type, the TEMP-VEL configuration does not lose its sensitivity when used at small water depths. On the other hand, a normal use of this system in shallow water is problematic because the vertical orientation of transmitter and receiver cables does not allow significant levels of the measured signals to be achieved.

This condition places restrictions on how deep a target can be detected by the use of TEMP-VEL in shallow water.

The invention has for its object to remedy or reduce at least one of the drawbacks of the prior art.

The object is achieved through features which are specified in the description below and in the claims that follow.

The invention discloses a novel method and apparatus for shallow and deep water electromagnetic prospecting of hydrocarbon reservoirs, including investigation of the reservoir geometry and determination of the water saturation of the formations included in the reservoir.

According to the first aspect of the invention, there is provided a novel method for the detection of a reservoir and determination of its properties by the use of the TM mode of the electromagnetic field induced in the subsea stratum. This electric field mode is very sensitive to resistive targets located in sedimentary, marine substrates. The electric measurements are carried out by the use of vertical receiver cable/cables if a horizontal line is used for setting up a current in the water. In the same way, the measurements are carried out by the use of horizontal receiver cable/cables if a vertical line is used to set up the electric current. In both cases the terminations of the transmitter cable and measuring electrodes will remain in the same vertical plane. Below, the term “an orthogonal setup” will be used to describe such an acquisition configuration.

According to the second aspect of the invention, an apparatus for determining the reservoir content exhibits an orthogonal configuration of transmitter and receiver cables, in order, thereby, either to generate the TM field or, alternatively, to generate both modes, but with measurement of only the TM field.

According to the third aspect of the invention, the transmitter generates and transmits through the cable a sequence of current pulses characterized by a sharp termination (rear front). The receiver measures the voltage difference which corresponds to the component of the electric field which is orthogonal to the straight line connecting the terminations of the transmitter cables. The measurement is carried out in the intervals between injected current pulses. The steepness of the rear front, the stability of the pulse amplitude and the duration of the pulse ensure the pulse-form independency of the measured response. This independency is maintained for measurement intervals corresponding to the depth of the target investigated.

According to a fourth aspect of the invention the measurement is carried out under near-zone conditions when the horizontal distance between the centres of the transmitter and receiver cables is smaller than the depth to the target.

According to a fifth aspect of the invention, a plurality of electrical receiver cables satisfying the geometric conditions given above is used for synchronous data acquisition to increase the survey effectiveness.

The main concepts of the present invention illustrated in the accompanying figures, in which the new TEMP-OEL (Transient Electromagnetic Marine Prospect-Orthogonal Electric Lines) configuration according to the invention is also compared with the conventional SBL frequency domain and TEMP-VEL time domain configurations. The responses of all three configurations are plotted for deep water (a water layer 1000 m thick) and shallow water (a water layer 50 m thick). In all the models the resistivity of the sea water equals 0.32 Ωm, whereas the resistivity of the above layer and half-space below the target layer, is 1 Ωm. The transversal resistance of the target layer is 2000 Ωm², corresponding to, for example, a layer 50 m thick with a resistivity of 40 cm.

With each of the configurations there has also been testing with target layers located at different depths below the seabed. The responses calculated for the thicknesses 1000, 2000, 3000, 4000 and 5000 m of the overlying layer are shown by different curves. There is also shown the response for a model without oil, a resistive layer not being present here.

The following figures and their descriptions are examples of preferred embodiments and should not be considered as limiting to the invention.

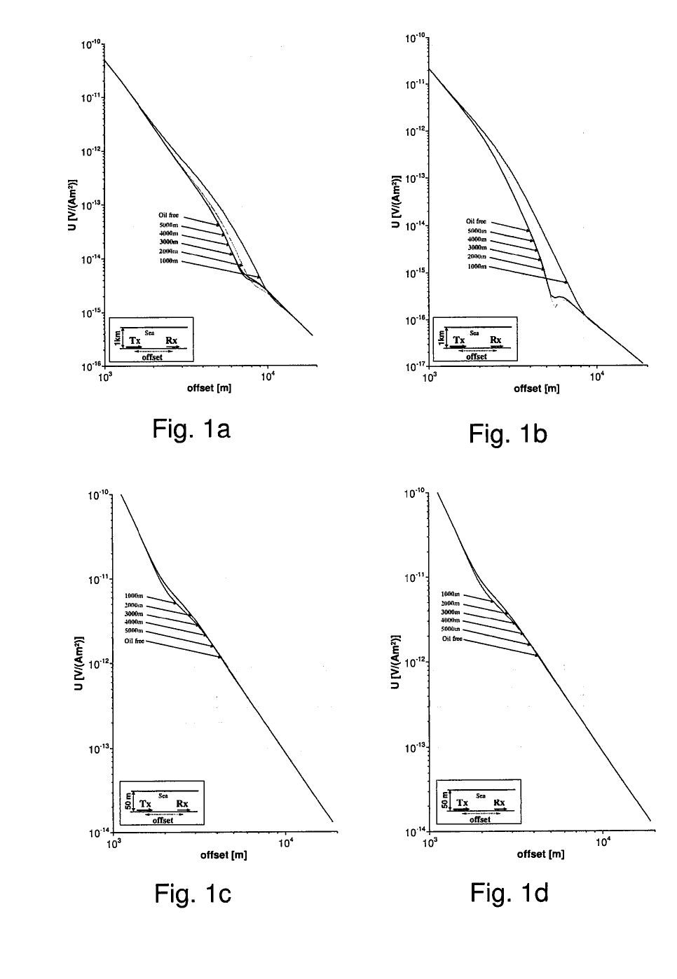

FIG. 1 shows the resolution of a conventional CSEM measurement (in-line TxRx configuration) which is based on voltage measurements in the frequency domain as a function of offset. This is a configuration much used for marine hydrocarbon exploration (SBL and other systems). Diagram (a) shows the response for a model for deep water for a period of 4 sec., diagram (b) relates to the same model for a period of 1 sec. In the same way the diagrams (c) and (d) show the responses for a model for shallow water for periods of, respectively, 4 sec. and 1 sec. All responses are normalized by the product of the source dipole moment and the length of the receiver dipole.

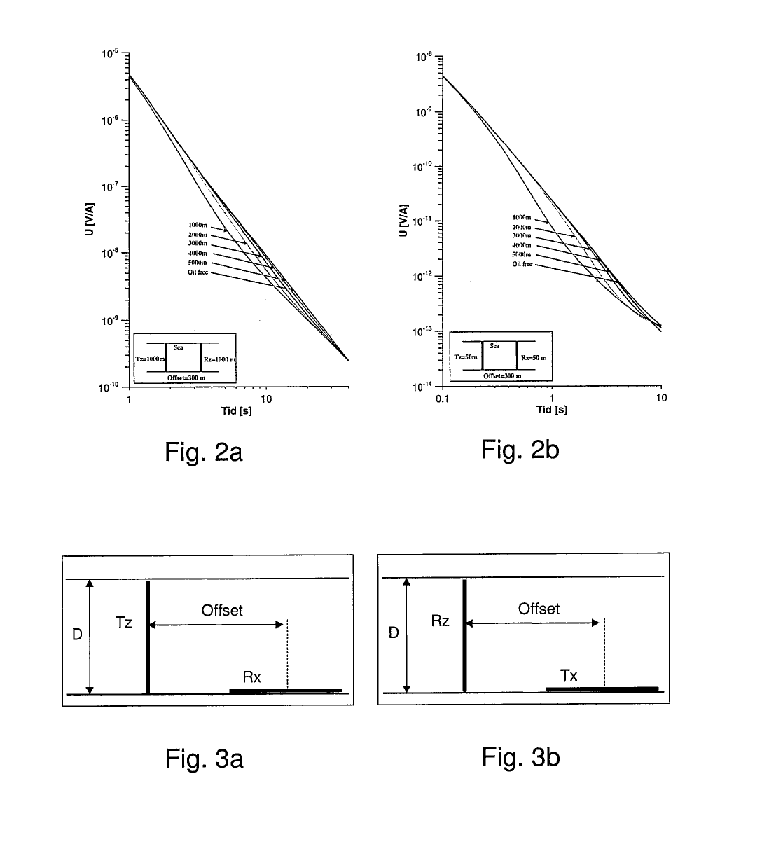

FIG. 2 shows the step-down voltage response as a function of time after the source has been switched off for the TEMP-VEL system according to Barsukov et al. (2005). The responses are shown for (a) deep and (b) shallow water. The offset is 300 m. The voltage is normalized by the impressed current.

FIG. 3 shows two alternative configurations for the TEMP-OEL system.

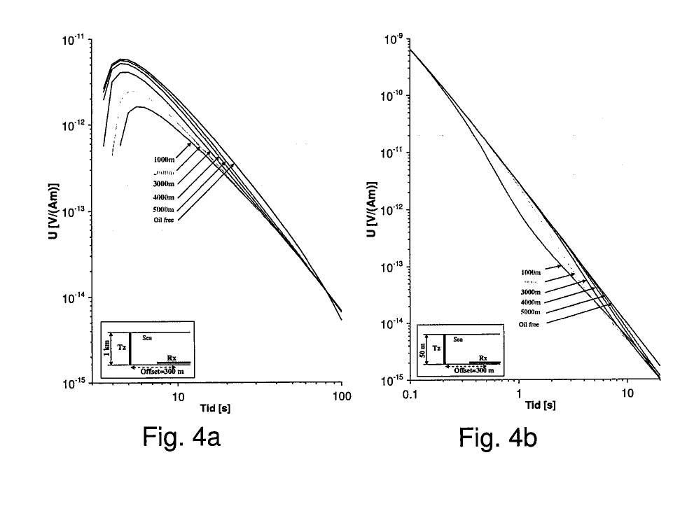

FIG. 4 shows the step-down voltage response as a function of time after the source of the new TEMP-OEL system has been switched off. The responses are shown for (a) deep and (b) shallow water. The offset is 300 m. For the TzRx configuration (corresponding to the configuration shown in FIG. 3a) the voltage is normalized by the product of the impressed current and the length of the receiver dipole; for the TxRz configuration the response is normalized by the source dipole moment.

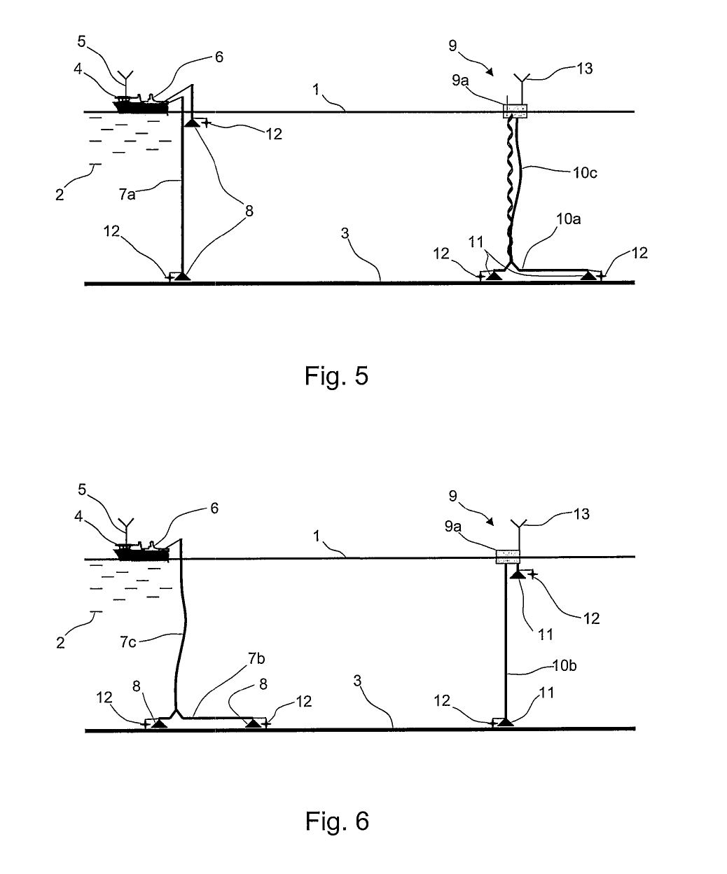

FIG. 5 shows schematically a side view of an electromagnetic surveying system with a vertical transmitter cable and horizontal receiver cables (corresponding to the configuration shown in FIG. 3a) according to the present invention.

FIG. 6 shows schematically a side view of an electromagnetic surveying system with a horizontal transmitter cable and vertical receiver cables (corresponding to the configuration shown in FIG. 3b) according to the present invention.

The method proposed according to the present invention can be applied in shallow and deep waters. It is characterized by high sensitivity and high resolution with respect to resistive targets. In addition, the new method and the new apparatus provide greater effectiveness in surveying than the TEMP-VEL system which uses vertical transmitter and receiver cables.

Firstly, the use of one of two possible configurations is achieved. In the first configuration the electric field is impressed by the use of a vertical cable creating only a TM-electromagnetic field in a stratified medium. In this configuration a horizontal, radially directed cable is used for registering the cross-sectional response. In the second configuration a horizontal transmitter cable is used for impressing current into the water, whereas a vertical receiver is used for measuring the vertical component of the electric field associated with the TM-field. In this way the system with mutually orthogonal transmitter and receiver cables measures the TM-mode response in the structure as high sensitivity to resistive targets is provided. At the same time, the deployment of a horizontal cable, which is used either for sending or receiving signals, provides the necessary signal level even though the survey is performed in shallow waters.

Secondly, tilt indicators are used on the lines to provide the necessary accuracy in the measurements.

Thirdly, the transmitter impresses a sequential series of current pulses on the transmitter cable, the rear front of the pulse being steep. To avoid complications connected with an imperfect form of the current pulses (Wright, 2005), the new method requires that the steepness of the rear pulse front, the pulse duration and the stability of the pulse amplitude satisfy accurate specifications in order for the response corresponding to the target depth of the survey to be independent of pulse form.

Fourthly, the system measures fields of dying current flowing in the stratum after the transmitter has been switched off. Data acquisition, data processing and data interpretation are carried out in the time domain.

Fifthly, the horizontal distance between the centres of the transmitter and receiver cables satisfies the conditions of near zone. This distance is smaller than the target depth, which is measured from the seabed.

One of the possible configurations of the new system is shown in FIG. 3a. In this configuration the system impresses electric current into the water by the use of a vertical transmitter cable Tz. Such a source creates a TM-electromagnetic field in a stratified medium. A horizontal receiver cable Rx is extended on the seabed. The length is chosen to provide a signal level which can be measured in a reliable is manner and with the required accuracy.

Another possible configuration according to the new system is shown in FIG. 3b. The system sets up electric current in the water, using a horizontal transmitter cable Tx. A vertical receiver cable Rz is used to pick up the signal. Such a receiver measures the Ez component of the electric field which is associated with the TM-mode. In this configuration the necessary signal level is provided by deployment of a transmitter cable of a corresponding length. Both configurations provide the same sensitivity to resistive targets.

The measured responses can be converted from voltage into apparent resistivity format either by direct conversion or by comparison with the response of a two-layer structure consisting of a sea water layer f of an appropriate thickness and a corresponding half-space.

The concepts forming the basis of the TEMP-OEL method as described hereinabove are realized in an apparatus according to the invention.

FIG. 5 shows a schematic view in which the reference numeral 1 indicates a water surface of a water layer 2 above a seabed 3 and with a vessel 4 floating on the water surface 1. A vertical transmitter cable 7a is terminated by water-filled transmitter electrodes 8.

A horizontal receiver cable 10a connects receiver electrodes 11 to a registration unit 9 comprising a surface buoy 9a and a connecting cable 10c.

The positioning and orientation of the electrodes 8, 11 are controlled by tilt sensors/transponders 12.

The vessel 4 is provided with a radio station 6 and an aerial 5. The registration unit 9 is provided with an aerial 13 for signal communication with the radio station 6 of the vessel 4.

FIG. 6 shows schematically a view of an alternative configuration, the reference numeral 7b indicating a horizontal transmitter cable and 10b indicating vertical receiver cables.

The horizontal transmitter cable 7b is connected to the vessel 4 via a connecting cable 7c.

In both configurations the measuring electrodes are to remain in the same vertical plane as the terminations of the transmitter cable.

In a main mode of operation of the TEMP-OEL, the vessel 4, transmitter 7a, 7b and receivers 11a, 11b are fixed in their positions for a period sufficient for achieving the prescribed quality of the acquired data. The radio station 6 and aerials 5, 13 are used for communication between the transmitter 7a, 7b and the receivers 10a, 10b, especially to control the data acquisition while the survey is going on. This enables repetition of measurements if, in a measurement, a satisfactory signal quality has not been achieved.

The tilt sensors/transponders 12 are used for accurate determination of the positions of the transmitter and receiver electrodes 8, 11.

The data acquired is processed, analysed and transformed into diagram plots for voltage/apparent resistivity versus time and depth and/or 1D inversion. Whenever necessary, transformation into 2.5D and 3D inversions and interpretation of these can be carried out.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A method of electromagnetic surveying of electrically resistive targets potentially containing hydrocarbon reservoirs, said method comprising the steps of:
determining electrical characteristics of strata to be investigated, using a TM mode of an electromagnetic field;
transmitting intermittent current pulses, having a sharp termination, in a submerged cable and acquiring a medium response during pauses between successive intermittent current pulses by the use of a receiver cable; and
measuring the stratum response in a near zone, with a horizontal source-receiver offset which satisfies the condition R<\sqrt{tρ_{α}(t)/μ₀}, in which t is a time lapse after the transmitter has been switched off, μ₀=4π·10⁻⁷ H/m, and ρ_{α}(t) is an apparent resistivity of a substratum for the time lapse t.

14. The method of electromagnetic surveying according to claim 13, further comprising using multiple receivers.

15. The method of electromagnetic surveying according to claims 13, further comprising controlling an orientation of the transmitter cable and transmitter electrodes with tilt sensors.

16. The method of electromagnetic surveying according to claim 13, further comprising measuring with moving or stationary sources and moving or stationary receivers.

17. The method of electromagnetic surveying according to claim 13, further comprising providing current pulses following in a particular sequence are incoherent with the noise, and measuring a response at each receiver stacked in order, thereby, to provide a signal-to-noise ratio sufficient for the purpose.

18. The method of electromagnetic surveying according to claim 13, further comprising further suppression of noise by means of registration of water pressure and temperature at a receiver locations.

19. The method according to claim 13, further comprising adjustment of at least one variable selected from the group consisting of: the continuation of the data acquisition, change of operational mode, change of location and retrieval of an instruments; based upon acquired data.

20. The method according to claim 13, wherein the intermittent current pulse is transmitted via a vertically oriented cable.

21. The method according to claim 13, wherein the intermittent current pulse is transmitted via a horizontally oriented cable.

22. The method according to claim 13, wherein the intermittent current pulse is received via a vertically oriented cable.

23. The method according to claim 13, wherein the intermittent current pulse is transmitted via a horizontally oriented cable.

24. An apparatus for the electromagnetic surveying of electrically resistive targets potentially containing hydrocarbon reservoirs, said apparatus comprising:
a submerged transmitter cable which is arranged to function as a transmitter of an electromagnetic field;
an electric power source and a transformer which are arranged to supply the transmitter cable with series of meander type pulses, a duration of an individual pulse being in a range of 0.01 to 50 seconds, with an amplitude of 100-5000 A and having a steep rear and front; and
a submerged receiver cable installed in a near zone of the transmitter and arranged to measure an electric field during a pause between the current pulses.

25. The apparatus according to claim 24, further comprising the receiver cables for receiving and simultaneously registering a component of the electric field within the near zone of the transmitter.

26. The apparatus according to claims 24, further comprising transponders and tilt sensors placed at an end of the transmitter and receiver cables.

27. Apparatus according to claim 24, further comprising a pressure sensor and a temperature sensor placed at the end of the receiver cables.

28. The apparatus according to claim 24, further comprising a means for real-time transmission of at least a selection of acquired data to a central processing unit.

29. The apparatus according to claim 24, further comprising the transmitter cable being vertically oriented.

30. The apparatus according to claim 24, further comprising the transmitter cable being horizontally oriented.

31. The apparatus according to claim 24, further comprising the receiver cable being vertically oriented.

32. The apparatus according to claim 24, further comprising the receiver cable being horizontally oriented.
